(19) United States
(12) Patent Application Publication
(10) Pub. No.: US 2014/0218530 A1
(43) Pub. Date: Aug. 7, 2014

(54) Traffic Event Detection System for Vehicles

(71) Applicant: Eric Sinclair, Leesburg, VA (US)

(72) Inventor: Eric Sinclair, Leesburg, VA (US)

(21) Appl. No.: 14/170,313

(22) Filed: Jan. 31, 2014

Related U.S. Application Data
(60) Provisional application No. 61/849,699, filed on Feb. 1, 2013.

(51) Int. Cl. G08G 1/00

(52) U.S. Cl. CPC G08G 1/00
USPC 348/148

(57) ABSTRACT

Platforms and techniques are described in which a traffic event detection system includes a camera connected to a central processor unit (CPU), and a video display with sound speaker also connected to the CPU. The camera is mounted outside the vehicle on an extendable and/or rotatable support, and captures images of traffic in front of the vehicle at a height generally above that of vehicles that may be ahead of the vehicle mounted with the detection system. The CPU can feed all of the images to the video display inside the vehicle visible to the driver. The CPU also analyses those images for sudden change in traffic pattern based on spectral content of the image stream, and can warn the driver with an audible sound if the cars in front of him or her break suddenly, or other traffic events occur.

### CROSS REFERENCE TO RELATED APPLICATIONS

The subject matter of this application is related to the subject matter of U.S. Provisional Patent Application No. 61/849,699, filed Feb. 1, 2013, entitled “Traffic Event Detection System for Automotive Vehicles,” by the same inventor herein, owned, assigned, or under obligation of assignment by or to the same entity as this application, to which application the benefit of priority is claimed, and which application is incorporated by reference herein in its entirety.

### FIELD

The present teachings are related to traffic event detection, and more particularly, to systems, platforms, and techniques for automotive and other vehicles to increase safety in case of sudden and abrupt change in traffic conditions by forward detection of hazardous or anomalous driving conditions.

### BACKGROUND

While driving on a highway, freeway, or other roads, traffic in front of a vehicle may suddenly or unpredictably slow down or come to an abrupt stop. To allow the driver of a vehicle to have greater situational awareness and respond faster to the changes in traffic condition, a system would be advantageous that is able to detect an event happening ahead of the vehicle, decode the event and, and alarm the motorist of the detected event in real-time or near real-time.

### SUMMARY

The system addressing these and other needs can comprise a sensor element, such as a video camera mounted on a vehicle to capture the images of the traffic ahead, a central processing unit (CPU) or other logic to process image streams captured by the camera, and software that analyses the images in the captured stream and detects events taking place ahead of the vehicle. The system can also include a video display that presents the images captured by the camera and a powered speaker to generate an audible alarm that warns the driver of the vehicle of troubles ahead.

According to aspects, while the vehicle is in motion, the camera can monitor or sample the field of view in front of the vehicle, including other vehicles in proximity to the vehicle equipped with systems according to the invention. In a case where one or more of the other vehicles slow down by applying the brake pedal, the software associated with the sensor can automatically detect an increase in red light intensity present in the field of view, due to the activation of brake lights in the vehicles ahead. The system can recognize that change in content, and notify the driver by emitting an alarm sound. A video display can also be installed inside the vehicle above the driver, for example near the sun visor, to present additional information and to provide the driver with complementary visual aid.

### DESCRIPTION OF DRAWINGS

The accompanying drawings, which are incorporated in and constitute a part of this specification, illustrate embodiments of the present teachings and together with the description, serve to explain the principles of the present teachings. In the figures:

FIG. 1 illustrates various components and configurations of systems and platforms according to aspects of the present teachings;

FIG. 2 shows a global view of a system installed on a vehicle with lateral view, according to implementations of the present teachings;

FIG. 3 shows a global view of a system installed on a vehicle in a 3D view, according to implementations of the present teachings;

FIG. 4 shows a detailed view of a monitor and how it may be mounted inside a vehicle, according to aspects of the present teachings; and

FIG. 5 shows an illustrative flow diagram of detection logic that can be used in implementations of the present teachings.

### DETAILED DESCRIPTION

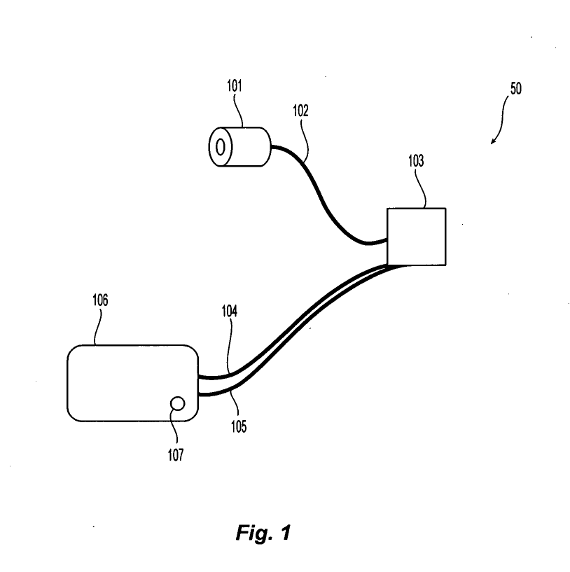

Referring to the drawings, FIG. 1 shows an illustrative overall system 50 not installed on a vehicle. The sensor 101 is connected to a CPU 103 by a cable 102. The sensor 101 can be or include, for example, a video camera, such as a digital device using a charge coupled device (CCD) sensor array. Other types of sensing elements or other devices can be used, including, merely for example, complementary metal oxide semiconductor (CMOS) sensing elements, and/or forward looking infrared (FUR) sensors. In implementations, sensors operating on other types of signals, such as acoustic sensors, can be used in addition to or instead of visual detectors. While sensor 101 is shown as being connected to the CPU 103 by a cable 102, which can for instance be or include a local area network (LAN) cable, other wired or wireless connections between the sensor 101 and CPU 103 can be used. For instance, in implementations, the sensor 101 can connect to the CPU 103 via a Bluetooth wireless connection, or others. The CPU 103 can be or include a general-purpose or special-purpose computer programmed with software, applications, and/or services to perform sensor control and image processing according to the teachings herein. Other devices configured to perform control logic can be used.

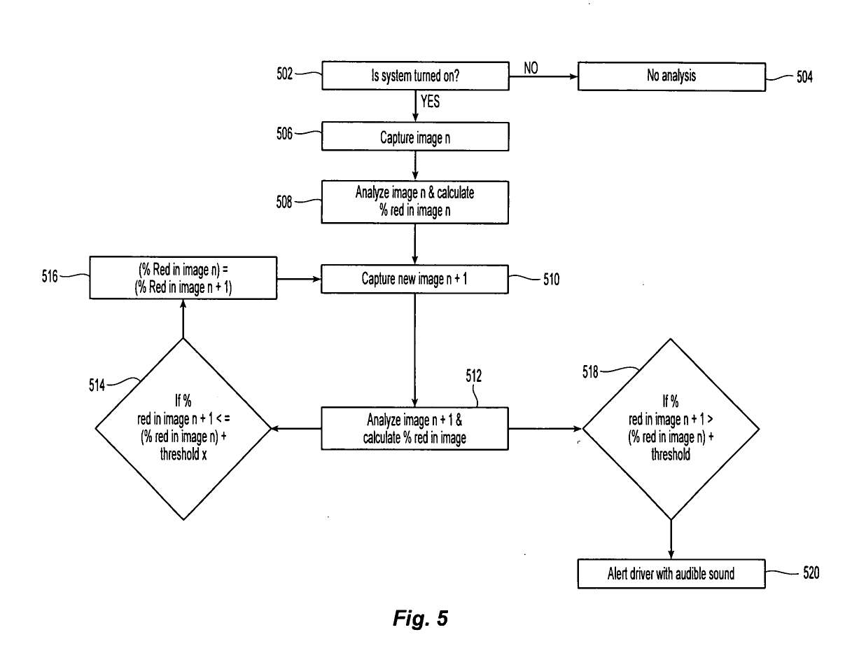

In general, the sensor 101 can operate to capture images in front of a vehicle equipped with system 50 for the CPU 103 to process. The CPU 103 can execute software and/or invoke services to analyze each of the images in the resulting image stream, and then use an algorithm such as the one illustrated in FIG. 5 to alert the driver of possible traffic events. At any point in time, when the system 50 is operating, the CPU 103 can be configured to send the images captured by the sensor 101 to a video display 106, for instance through a connecting cable 104. If the CPU 103 and associated software or logic have detected a traffic event and need to alert the driver, the CPU 103 can in implementations do so by transmitting an audible alarm through cable 105 to a speaker 107. Other alerts or notifications, such as flashing lights or other visual cues, can also be used.

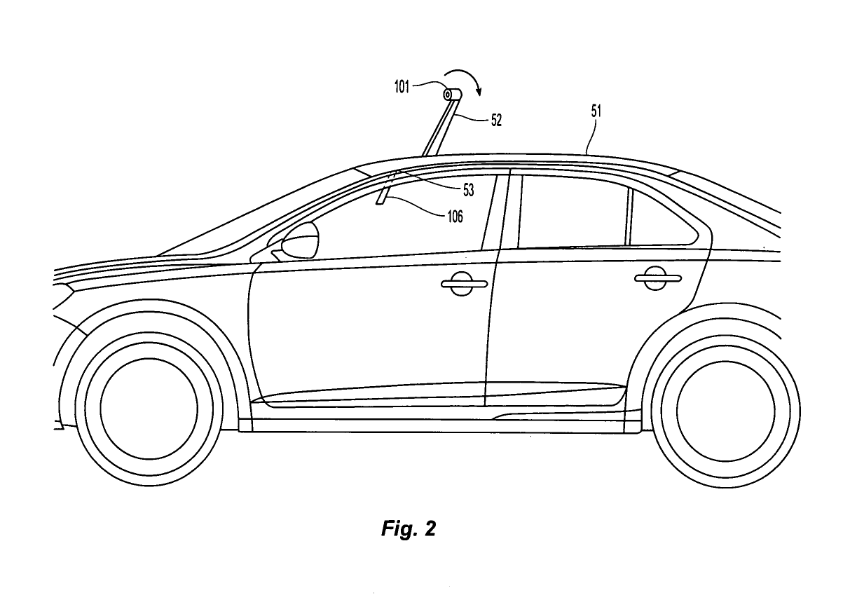

FIG. 2 shows the system 50 as mounted or installed on a vehicle 51. The sensor 101 can be installed on a support 52. The support 52 can, in implementations, be a rigid element constructed to be high enough to be located above the vehicles ahead. In other implementations, the support 52 can be or include a retractable or articulated element, so that the support 52 can for instance be placed in a folded-down or prone position when not in use, such as in a recess or channel in the roof or other structure of the vehicle 51. The support 52 in those cases can be driven by a motorized drive to an upright state or position, or returned to a resting state in the recess or other receiving structure or position. In implementations, the support 52 can also or instead be implemented using a telescoping element, for instance to allow an adjustable or selectable height to be reached. In implementations, the motorized drive of the support 52 can likewise be controlled by the CPU 103, and/or other or separate processors or logic.

By mounting the sensor 101 on an extendable support 52, the system 50 can achieve a higher and/or selectable elevation of the CCD or other sensing elements of the sensor 101. The capability to elevate the sensor can permit the sensor to “see” a greater depth or distance into the field of view, and/or a wider viewing range, than if the sensor were mounted in a fixed manner to the body of the subject vehicle 51 equipped with the system 50. The greater viewing depth can allow the system 50 to detect and take into account the brake light activity or other details produced by more vehicles located farther ahead of the vehicle equipped with the system 50. This can allow the system to draw inferences about traffic events based on a larger number of brake light and other features, thus enhancing sensitivity, accuracy, and other parameters of system 50.

In addition, it will be noted that besides an extendable or articulated support 52, the sensor 101 can be mounted on the support 52 in a rotatable and/or otherwise articulated fashion. For example, the sensor 101 can be attached to the support using a rotary drive element, so that the sensor 101 can be rotated from side to side when the support is in an extended or deployed position. For instance, the sensor 101 can be mounted to the support with a motorized drive to permit horizontal rotation of 180 degrees on a horizontal plane or other amounts, to allow the driver of the vehicle to pan the field of view of the sensor with regard to traffic ahead. In implementations, the sensor 101 and/or mount 102 can be configured to permit vertical adjustments as well, to change the vertical pointing angle and hence range of view provided by the sensor 101 ahead of the subject vehicle. The one or more motors or drives used to drive motion of the sensor 101 can be or include, for instance, direct current (DC) motors, stepper motors, linear motors, and/or others, as understood by persons skilled in the art. Those motorized drives can transmit the driving force to support 52 and/or other members using gears, bearings, and/or other mechanical transmissions.

In terms of internal configuration inside the subject vehicle equipped with system 50, the video display 106 can be mounted on the ceiling 53 of the car or other subject vehicle 51. The video display 106 can be fixed, or can rotate along an axis like a visor, to allow the driver to place the video display 106 at a convenient angle for viewing.

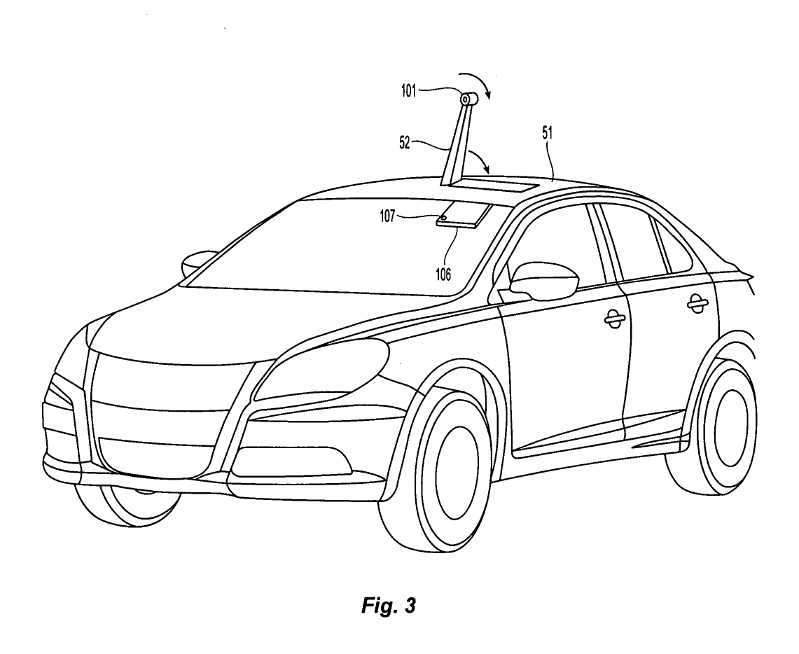

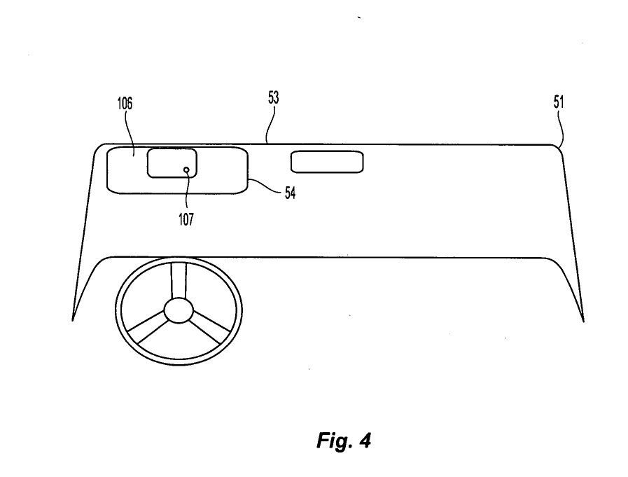

FIG. 3 illustrates the system 51 mounted on a vehicle 50, but in a further, three-dimensional view. The sensor 101 as shown is installed on a support 52. The video display 106 is shown from the back of that element. As noted a speaker 107 can be used to provide audible warnings or annunciations of traffic events, and can as shown be installed on the video display 106, and/or in other locations. FIG. 4 shows the video display 106 from inside the vehicle 51. The video display can be attached to the ceiling 53, and again can be pulled down the same way the sun visor 54 can rotate. The sound speaker 107 is attached to the video display 106.

FIG. 5 shows a diagram of illustrative processing to analyze the stream of images captured by the sensor 101. In general, each of the images captured by the camera can be compared with the previous image. Differences between successive image frames can be used to determine if a traffic event is taking place. For instance, the spectral content of different image frames can be compared to determine if the color content of the field of view is changing. For instance, in implementations, if the second, or new image, has more red intensity than the previous one by some threshold, the detection of an event can be triggered. The threshold used to measure changes in red content can be predetermined or set, for instance, to a fixed threshold X by the car manufacturer or manufacturer of the system 50. The threshold can also or instead by dynamically set or adjusted by the CPU 103, for instance, to take into account ambient conditions, such as red light content from a sunset, sodium vapor lamps along a roadway, or other light sources. As noted, upon detection of a traffic event, an audible alarm and/or other notification can be sent to the driver.

More particularly as shown in FIG. 5, in 502 processing can begin by making a determination whether system 50 is turned on, powered, and/or otherwise in an operational state. If the determination in 502 is no, processing proceeds to 504 in which no analysis is performed. If the determination in 502 is yes, processing proceeds to 506, in which the sensor 101 captures image number “n.” In aspects, the captured image can consist of one video frame, and/or other image formats or configurations. In implementations, the captured image and/or image stream can be encoded in standard image formats, such as motion picture experts group (.mpg) format, joint photographic experts group (.jpg) format, raw image format, and/or other formats, encodings, or file types. The sensor 101 can be configured to capture each successive video frame or other unit of data using a predetermined frame rate, such as 30 frames/sec, or others. The image date captured by sensor 101 can be stored by CPU 103 to local storage, such as electronic memory, solid state drives, hard drives, and/or other storage media, if desired.

In 508, the CPU 103 and/or other processor or logic can analyze the color content of the captured frame n, such as for instance by calculating the percentage of red color content in that image content. Red may be used because that color is produced by standard rear brake lights. It will however be appreciated that other colors can be used in addition or instead when performing a spectral or color analysis of image n. It will also be appreciated that image processing characteristics or signatures other than color content, such as luminance values, motion analysis, or others can likewise be used to analyze the scene or view in front of the vehicle equipped with system 50. In 510, the sensor 101 can capture or acquire a next image or image frame “n+1,” acting together with the CPU 103 can capture or acquire a next image or image frame “n+1.” In 512, the CPU 103 and/or other processor or logic can similarly calculate the percentage of red color content, or other spectral or other signature, in image or image frame n+1. In 514, the CPU 103 and/or other logic or processor can determine if the percentage of red color content in image or image frame n+1 is less than or equal to the percentage of red color content in image or image frame n, then processing will proceed to 516, in which a determination can be made that the color content of image/frame n and n+1 are equal. In that case, processing can return to 510. In aspects, processing can return to 510 (and acquire a further image or frame) because no change in red-color content is detected, and the total brake light illumination is assumed to be the same, with no sudden change in forward traffic conditions.

In 518, the CPU 103 and/or other processor or logic can determine that if the percentage of red color content in image or frame n+1 is greater than that of image or frame n plus a selected threshold (e.g., 10% or other value), then processing will proceed to 520 in which a traffic event is deemed to be detected and the driver can be alerted with an audible sound or other alert or notification. In embodiments, the alert or notification can continue until the driver hits a cancel button, a predetermined timeout takes place, or other conditions occur. Processing can then return to a prior processing point (e.g., 502), jump to a further processing point, or end.

The foregoing description is illustrative, and variations in configuration and implementation may occur to persons skilled in the art. For example, while implementations have been described in which system 50 operates using one sensor 101, in implementations, two or more sensors 101 can be employed. Similarly, while embodiments have been described in which image processing and control logic are executed in one CPU 103, in implementations, multiple CPUs and/or networked or remote computing resources or services can be used, including those hosted in a cloud-based network. Other resources described as singular or integrated can in embodiments be plural or distributed, and resources described as multiple or distributed can in embodiments be combined. The scope of the present teachings is accordingly intended to be limited only by the following claims.

What is claimed:

1. A sensor assembly, comprising:
an extendable support, the extendable support being configured to be mounted to a vehicle;
a sensor, the sensor being adapted to be attached to the extendable support and configured to generate an image stream in front of the vehicle; and
control logic, connected to the sensor, the control logic being configured to-analyze the image stream, and
detect a traffic event in front of the vehicle based on the image stream.

2. The assembly of claim 1, wherein the extendable support comprises a support arm configured to rotate from a prone position to an upright position.

3. The assembly of claim 2, wherein the extendable support is driven by a motorized drive.

4. The assembly of claim 1, wherein the upright position is at an elevation higher than a height of other vehicles located in front of the vehicle.

5. The assembly of claim 1, wherein the sensor is attached to the support using an articulated attachment.

6. The assembly of claim 5, wherein the articulated attachment rotates at least 180 degrees on a horizontal plane when the extendable support is in the upright position.

7. The assembly of claim 1, wherein the analyzing the image stream comprises analyzing a color content of the image stream.

8. The assembly of claim 7, wherein detecting a traffic event comprises detecting a change in red-color intensity from a current image frame compared to a prior image frame.

9. The assembly of claim 1, wherein the sensor comprises a video camera.

11. A method of detecting traffic events, comprising:
receiving an image stream from a sensor mounted to an extendable support on a vehicle;
determining a spectral content of a current image frame of the image stream;
comparing the spectral content of the current image frame to a spectral content of a prior image frame of the image stream; and
identifying a traffic event based on a change in the spectral content between the current image frame and prior image frame.

12. The method of claim 11, wherein spectral content comprises red-color content.

13. The method of claim 12, wherein the comparing comprises determining whether the red-color content has changed by more than a threshold.

14. The method of claim 11, further comprising generating an alert to a driver of the vehicle based on the identification of the traffic event.
